(19) United States
(12) Patent Application Publication
(10) Pub. No.: US 2012/0212896 A1
(43) Pub. Date: Aug. 23, 2012

(54) INTEGRATED COMPUTER CASE

(76) Inventor: Daniel Helmut Schulz, Salt Lake City, UT (US)

(21) Appl. No.: 13/397,439

(22) Filed: Feb. 15, 2012

Related U.S. Application Data
(60) Provisional application No. 61/443,075, filed on Feb. 15, 2011.

(51) Int. Cl. G06F 1/16

(52) U.S. Cl. 361/679.02

(57) ABSTRACT

A computer case containing a computer pad with electrical port, and Jumper cable removably coupled to the electrical port. A bottom compartment defined by a first and second pair of opposed bottom walls connected by a bottom wall. A top cover, including a first and second pair of opposed top walls connected by one top wall. A spacing layer, formed to substantially fill the bottom compartment. Wherein a computer pad cavity in a central region of the spacing layer has a first and second pair of opposed spacing walls connected by a spacing wall that the computer pad rests upon. A jumper cable cavity extending from an edge of the computer pad, positioned next to the electrical port, terminating at a case electrical port. Wherein the jumper cable within the cavity may be coupled to the computer pad and one of the first and second pair of opposed bottom walls.

### CROSS REFERENCE TO RELATED APPLICATION[S]

This application claims priority to U.S. Provisional Patent Application to Daniel Schulz entitled “An Integrated Computer Case” Ser. No. 61/443,075 filed Feb. 15, 2011 the disclosure of which is hereby incorporated entirely herein by reference.

### FIELD OF THE INVENTION

The present invention relates to computer cases, specifically it relates to computer cases that are integrated with the features of the note pad computer.

### DESCRIPTION OF THE RELATED ART

In the related art, it has been known to use cases to store electronic equipment, and especially lap top computers. However, lap top computer cases are not suitable for note pad computers in form, design, functionality, suitability, or other specification issues. Some improvements have been made in the field. Examples of references related to the present invention are described below, and the supported teachings of each reference are incorporated by reference herein:

U.S. Design Pat. No.: D306,433, issued Mar. 6, 1990 to Mitchell, discloses a laptop computer.

U.S. Pat. No. 5,379,893, issued Nov. 15, 1993 to Rlliz, discloses an attaché case has a partition whose upper surface supports a laptop or notebook computer. The computer is removably affixed to the partition by hook and loop fasteners or the like, and the fasteners may be easily repositioned or replaced when one upgrades or changes computers. Placement of the computer in the upper half of the case better conceals its existence, and when used, the computer is more accessible because of its elevation.

U.S. Pat. No. 5,400,903, issued Mar. 28, 1995 to Cooley, discloses a multi-use notebook computer carrying case includes a top cover member and a bottom cover member. An accordion-like shroud connects the sides of the top and bottom cover members. A bottom tray having a height adjust mechanism is secured within the bottom cover member. The bottom cover member houses a plurality of drawers capable of being extended away from the bottom cover member to expose a storage compartment and provide additional working surface area. The bottom cover, member further includes a height adjustable wrist pad. A protective windshield housed within the top cover member, is selectively engageable to protect against a hostile environment.

U.S. Pat. No. 5,485,922, issued Jan. 23, 1996 to Butcher, discloses a portable computer carry case assembly, to be used to safely and securely contain and transport a portable computer and various accessories therefor, the assembly having a main housing which is divided into a top compartment and a bottom compartment by a divider panel. Included within the top compartment are various support members which receive the portable computer suspended thereon in such a manner that the keyboard portion of the portable computer will be co-planar with a top edge of the main housing, and which straddle the portable computer to prevent sliding within the top compartment. Also included in the top compartment is a surge suppressor/power conditioner, which is exteriorly accessible through a power cord outlet disposed in one of the walls of the main housing, and a connector access disposed in the divider panel to facilitate access between the top and bottom compartments, the bottom compartment being structured to contain a portable computer printer and various other computer accessories which are accessible through a main opening of the bottom compartment. The main opening is sealable by a closure flap, and the top compartment is sealable by a lid hingedly secured to a top edge of one of the walls. Finally, at least one wheel and an extendable handle are included and utilized to allow the entire assembly to be conveniently pulled along atop the wheel, the entire assembly being structured to qualify as an airplane carry-on item.

U.S. Pat. No. 5,494,157, issued Feb. 27, 1996 to Golenz, et al., discloses a computer case which provides a main packing space for the microcomputer defined by a “c” shaped rigid frame and corresponding shock absorbing pad, the forth side of the packing space is selectively closed by a padded access door. The handle and/or shoulder strap is riveted to the upper side of this “C” shaped frame. The access door is integrally hinged to the lower side of the frame, and is secured to the case when closed by double slide fastener and hook and loop fasteners.

U.S. Pat. No. 5,524,754, issued Jun. 11, 1996 to Hollingsworth, discloses a carrying ease for electronic equipment such as a notebook computer includes a pair of opposed walls, a plurality of side walls connected therebetween to define a principal compartment for receiving the notebook computer, and a suspension member affixed to an upper portion of one of the opposed walls and depending downwardly therefrom into the principal compartment. The suspension member includes upper and lower supports to cradle the notebook computer and an elastic panel disposed between the upper and lower supports to absorb any shock which would otherwise occur due to the carrying case being abruptly dropped. Alternatively, the suspension member can be an elastic panel having opposed ends supported by an upper portion of one of the opposed walls to define an elastic sling which depends downwardly from the wall within the principal compartment to receive the notebook computer. The suspension member can also be releasably connected between the opposed walls to define a shock absorbing cradle which can be removed so that the carrying case can be used for other purposes.

U.S. Pat. No. 5,564,930, issued Oct. 15, 1996 to Yu, discloses There is disclosed a case (12) for a computer having one of a plurality of removable and interchangeable rear panels (50, 90) which provide apertures for access to I/O ports and slots for access to the rear edges of accessory cards (17, 123) of any of various mother boards (13) such as the IBM, Western Digital or Intel mother boards. For this purpose the case has a window (70) in its rear wall (22) which is generally rectangular with an extension along its lower edge. The window receives one of a plurality of removable and interchangeable panels (50, 90), each panel having a first area which is a generally rectangular recessed wall (74, 118) having a plurality of elongated slots (76, 106) that provide access to the rear edges of accessory cards, and a second area, located along the lower edge of the panel which has one or more apertures (88, 94, 96, 98, 100, 102, 104) to provide access to I/O sockets of a mother board. Each panel has a plurality of tabs (58, 114) with apertures to receive screw fasteners (72,116) for attachment of the panel to the rear wall of the case. Additionally, the recessed wall of the panels also includes a plurality of threaded apertures (80, 139), one each located adjacent one of the elongated slots for receiving a screw fastener to secure the rear of an accessory card.

U.S. Pat. No. 5,682,993, issued Nov. 4, 1997, to Song discloses a multipurpose cover for transporting and protecting a portable personal computer is formed by upper and lower rectangular trays joined by a zipper. The computer remains attached to and partially enclosed by the trays while being operated, and may be conveniently connected to an external printer, monitor or other peripheral device through apertures formed in at least one of the rectangular trays. Elastic flaps equipped with snap fasteners cover the apertures when not in use, and rubber struts may be attached to the bottom of the lower tray to control the angle of keyboard. A company name or logo may be embossed on an external surface of the cover for advertising purposes.

U.S. Pat. No. 5,871,094, issued Feb. 16, 1999 to Leibowitz, discloses a laptop computer case and stand (10) comprising a base (12) having a compartment (14) for holding a laptop computer (16) therein. A lid (18) is hinged at (20) to the base (12). A facility (22) along a rear edge of the lid (18) is for engaging an upper surface of a pair of legs (24) of a person (26) sitting in a chair (28), when the lid (18) is opened. A component (30) on the lid (18) is for transporting the base (12) and the lid (18) by the person (26), when the lid (18) is closed, so as to be conveyed to various locations.

U.S. Pat. No. 5,960,952, issued Oct. 5, 1999 to Chen, discloses a protective briefcase for a notebook computer is provided comprising a briefcase body consisting of five side panels and a cover, said briefcase body and cover being able to be engaged to or separated from each other by using a zipper, characterized in that the five side panels of said briefcase body and said cover are comprised of an outer fabric layer, an inner fabric layer, and a laminated reinforcing layer between said outer and inner fabric layers, wherein said laminated reinforcing layer is comprised of in sequence from outside to inside a hard shock-absorbing outer layer, a flexible thin plate, and a soft shock-absorbing inner layer such that a sandwich structure is formed in order to abut against the surfaces of said notebook computer contained in said protective briefcase.

U.S. Pat. No. 5,992,i55, issued Nov. 30, 1999 to Kobayashi, et al., discloses a case appropriate for holding a notebook computer for use of the notebook computer while held in the case. The notebook computer storage case uses a member with high thermal conductivity at least in a position contacting the bottom of a computer located in the case.

U.S. Pat. No. 6,105,763, issued Aug. 22, 2000 to Saetia, discloses an improved carrying case for a laptop computer or other delicate instrument is disclosed. The improved computer carrying case allows access to the stored computer/instrument via more than one opening to permit use and operation of the instrument without requiring extensive unpacking, particularly during transit when there is an enhanced risk of damage to the stored computer/instrument. The case, further, may allow storage of peripheral devices, including those to be used with the stored computer. The case may also be used to simultaneously store catalogs, manuals and other papers, thus making it a versatile aid to mobile users.

U.S. Pat. No. 6,105,764, issued Aug. 22, 2000 to Scicluna, et al., discloses a computer carrying case has an outer receptacle with walls of flexible material joined to form a fully enclosed volume. The outer receptacle receives a computer receptacle having front and back walls that include substantially rigid panels and that are coupled together at the ends by devices that permit the width of the computer receptacle between the front and back walls to be adjusted so that laptop computers of different thicknesses can be accommodated reasonably snugly.

U.S. Pat. No. 6,109,434, issued Aug. 29, 2000 to Howard, Jr., discloses an improved protective case for a portable, or laptop, computer is described. In particular, a protective case designed such that the computer may be kept therein during transport, storage, or use, is described. The protective' case provides flexible hinge means to accommodate opening and closing the computer and case while the two remained attached to each other. The protective case contains means for protecting the computer from damage that may result from physical shock. The protective case provides for convenient access to all four sides of the portable computer, where necessary user interfaces, such as cable connectors, accessory ports and disk drives, are typically found, when the protective case is open, and protection therefor when the protective case is closed.

U.S. Pat. No. 6,116,418, issued Sep. 12, 2000 to Sadow, discloses a pair of complementary securement members are provided for securing an article of portable equipment, such as a laptop or palm held computer, within a portable carrying case. Since the thickness of the securement member attached to the base of the portable computer may interfere with the operation of non-slip frictional members which conventionally depend from the base of the portable computer, supplemental frictional members are provided in conjunction with the securement member. The supplemental frictional members project beyond the remaining portion of the securement member to engage a supporting surface (e.g., table or desk) when the portable computer is removed from its portable carrying case.

U.S. Pat. No. 6,149,001, issued Nov. 21, 2000 to Akins, discloses a cover for a portable computer is a thin flexible material adapted to fit closely over the computer like a glove. The cover has cut-outs for the keyboard, screen, controls, ports, etc. of the computer so that the cover does not interfere with convenient use of the computer. The cover is compact and adds little additional volume or weight to the computer, while protecting the computer housing or case, providing an attractive appearance and also providing convenient accessories, such as pockets for a power supply cord, floppy disks, CD ROM disks, pencils, etc. The computer may be carried or used with the cover installed.

U.S. Pat. No. 6,618,245, issued Sep. 9, 2003 to Diaz, discloses an access door assembly for a computer case in which a drive door can be easily opened, thereby allowing access to the module data storage media drive which is connected to the removable door. Advantageously, the use of an access door which is easily opened facilitates upgrade and/or maintenance and repair of the removable media drive. The media drive can be, for example, a floppy disc drive or a hard disc drive. Because of the ease of use, the access door can be opened by a person without any technical skill, thereby lowering warranty costs. Maintenance and upgrades can be done by an unskilled consumer without the necessity of either having to ship the computer back to the manufacturer or have a service technician visit the consumer.

U.S. Patent Application No.: 2004/0264126, published Dec. 30, 2004 to Wells, discloses a physical, expandable, customizing, configuring component chassis for laptops, tablets, notebooks, and hybrid notebooks transforms literally. The case is in three main parts: the top, upper lid, the middle, inner cover, and bottom housing. This removable upper lid houses the display screen on the inside and the solar cells on the back of the lid. The next section is the slim, narrow, middle, inner unit which holds the speakers, mouse pads, keyboards, LDC readout, small display screen, motherboards, expansion cards, and controller cards. It is detachable from the top or bottom section of the case forming a diversified case. The bottom of the case has the physical, drawer like, expandable, slidable ends to the right and left of the front of the case and knockout panels, which are for mounting the face of the peripherals. A part of the bottom will be the unique sliding ends, snap-in components mounting to the removable mounting board. The mounting board will be screwed in to be secure. The middle and bottom sections can be separated into a two piece case. This case will be composed of a top lid and either/or middle or bottom section, forming a complete computer housing.

U.S. Pat. No. 6,871,739, issued Mar. 29, 2005 to Lopez, discloses a foldable carrying ease for a notebook computer which has two states an open state wherein the notebook computer can be used on the open case and a closed state wherein the notebook computer can be transported with the computer being protected with padding on all 6 faces of the computer. The computer case is sized closely to the dimensions of the computer to provide a carrying case that is approximates the dimensions of the case plus the thickness of padding.

U.S. Design Pat. No.: D531,409, issued Nov. 7, 2006 to Tullmann, et. al., discloses a laptop computer case.

U.S. Patent Application No.: 20060289444, published Dec. 28, 2006; to Jackson, et. al., discloses a case configured to enclose a portable electronic device includes a plurality of externally accessible electrical contacts, enabling electrical current to flow to or from the device while enclosed in the case. The invention is applicable to all types of portable devices, including laptop, notebook and palm-top computers, as well as telecommunications devices, video players and music players. Typically the electrical contacts allow a battery in the case or in the device to be recharged while device is enclosed. An adaptor cable may be provided between the device and the electrical contacts so that the same or similar case may be used with different model devices from different manufacturers. For greater ‘universality,’ a voltage-changing adaptor cable may be provided within the case between the device and the electrical contacts. The system may further include a docking bay to receive the case, the docking bay having a set of electrical contacts configured to electrically engage with the contacts on the case. Such a docking bay may take the form of a charging stand, a cart with one or more slots or compartments, or a locker with a door and a storage compartment.

U.S. Design Pat. No.: D543,700, issued Jun. 5, 2007 to Parker, et al., discloses a notebook computer case.

The inventions heretofore known suffer from a number of disadvantages which include the same case does not fit other computers, nor has there been a computer case suitable to the design of the new note book computers. Additionally, computer cases do not have easy access to the computer power, mouse, secondary screen, ear phone connections once the computer is placed in the case. Moreover, these prior alt cases do not have simplified paper storage inside the case, nor simple paper holding systems outside the case. Additionally, the current art does not provide for maintaining the computer pad inside the case while orientating the screen in a somewhat vertical angle (say 20 to 90 degrees from the level position) to allow for easy visibility to a group of people sitting a distance away from the screen.

What is needed is a computer case for a computer pad that solves one or more of the problems described herein and/or one or more problems that may come to the attention of one skilled in the art upon becoming familiar with this specification.

The present invention has been developed in response to the present state of the art, and in particular, in response to the problems and needs in the art that have not yet been fully solved by currently available computer case designs. Accordingly, the present invention has been developed to provide a computer case suitable to the design of the note book computer.

Another potential advantage of the presently described and/or illustrated invention provides for a computer case that has easy access to the computer power, mouse, secondary screen, ear phone connections and other attachments once the computer is placed in the case.

Yet a further potential advantage of the presently described and/or illustrated invention provides for a computer case that has simplified paper storage inside the case, nor simple paper holding systems outside the case

Additionally, another potential advantage of the presently described and/or illustrated invention provides for maintaining the mounting of the computer pad inside the case while being oriented in a somewhat vertical angle (say 20 to 90 degrees from the level position) to allow for easy visibility to the user or a group of people sitting a distance away from the screen.

Reference throughout this specification to features, advantages, or similar language does not imply that all of the features and advantages that may be realized with the present invention should be or are in any single embodiment of the invention. Rather, language referencing to the features and advantages is understood to mean that a specific feature, advantage, or characteristic described in connection with an embodiment is included in at least one embodiment of the present invention. 11 ms, discussion of the features and advantages, and similar language, throughout this specification may, but do not necessarily, refer to the same embodiment.

It is another possible feature of the illustrated embodiments to provide a computer case that is designed to contain a computer pad with an electrical port, and Jumper cable removably coupled to the electrical port. There is a bottom compartment, defined by a first and second pair of opposed bottom walls that are all connected by one bottom wall. There is a top cover, including a first and second pair of opposed top walls all connected by one top wall. There is a spacing layer, formed to substantially fill the bottom compartment. Wherein a computer pad cavity is formed in a central region of the spacing layer and creating a first and second pair of opposed spacing walls all connected by one spacing wall therebelow that the computer pad rests thereon. There is a jumper cable cavity that extends from an edge of the computer pad, positioned next to the electrical port, and terminates at a case electrical port. The jumper cable cavity enables the jumper cable to be placed therewithin and be coupled to the computer pad and one of the first and second pair of opposed bottom walls of the bottom compartment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 a illustrates a perspective view of one embodiment of the invention positioned in a horizontal orientation while being closed to access to the interior therein;

FIG. 1 b illustrates a perspective sectional phantom line view of one embodiment of an interior electrical coupling;

FIG. 2 illustrates a perspective view of one embodiment of the open case of FIG. 1;

FIG. 3a illustrates a perspective view of one embodiment of the open case of FIG. 2;

FIG. 3b illustrates a sectional perspective view of FIG. 3a with the case housing removed.

FIG. 3c illustrates a sectional perspective view of FIG. 3a with the case housing removed.

FIG. 4 illustrates a cross sectional view of FIG. 3 in a closed position;

FIG. 5 illustrates a cross sectional view of another embodiment of the illustrated invention having only one interior cavity for the computer pad;

FIG. 6 illustrates a perspective view of another embodiment of the invention positioned in a horizontal orientation while being closed to access to the interior therein;

FIG. 7 illustrates a side view of one embodiment of the propped up and open case from FIG. 6; and

FIG. 8 illustrates a back view of FIG. 7 while in the propped up and open case position.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

By way of definition, reference throughout this specification is made to a note pad computer, or computer pad. The computer pad is specifically and generally referring to those electrical devices that are characterized in being a single structure with a single screen at least four inches tall and two inches wide with the back of the screen encompassing all of the necessary computer components to electronically operate the simple basics of the computer pad. Reference is specifically made, and is herein incorporated by reference for supporting teachings, to U.S. Pat. No. 5,563,996 titled: Computer Note Pad Including Gesture Based Note Division Tools and Method, assignee of Apple Computer, Inc. of Cupertino, Calif., filed on Sep. 24, 1993.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional un-recited elements or method steps. “Comprising” is to be interpreted as including the more restrictive terms “consisting of” and “consisting essentially of.”

The present invention has been developed in response to the present state of the art, and in particular, in response to the problems and needs in the art that have not yet been fully solved by currently available computer case designs. Accordingly, the present invention has been developed to provide a computer case suitable to the design of the note book computer.

Another potential advantage of the presently described and/or illustrated invention provides for a computer case that has easy access to the computer power, mouse, secondary screen, ear phone connections and other attachments once the computer is placed in the case.

Yet a further potential advantage of the presently described and/or illustrated invention provides for a computer case that has simplified paper storage inside the case, nor simple paper holding systems outside the case.

Additionally, another potential advantage of the presently described and/or illustrated invention provides for maintaining the mounting of the computer pad inside the case while being oriented in a somewhat vertical angle (say 20 to 90 degrees from the level position) to allow for easy visibility to the user or a group of people sitting a distance away from the screen.

Another potential advantage of one embodiment of the invention provide for a computer case that is designed to contain a computer pad with an electrical port, and Jumper cable removably coupled to the electrical port. There is a bottom compartment, defined by a first and second pair of opposed bottom walls that are all connected by one bottom wall. There is a top cover, including a first and second pair of opposed top walls all connected by one top wall. There is a spacing layer, formed to substantially fill tile bottom compartment. Wherein a computer pad cavity is formed in a central region of the spacing layer and creating a first and second pair of opposed spacing walls all connected by one spacing wall therebelow that tile computer pad rests thereon. There is a jumper cable cavity that extends from an edge of the computer pad, positioned next to the electrical port, and terminates at a case electrical port. The jumper cable cavity enables the jumper cable to be placed therewithin and be coupled to the computer pad and one of the first and second pair of opposed bottom walls of the bottom compartment.

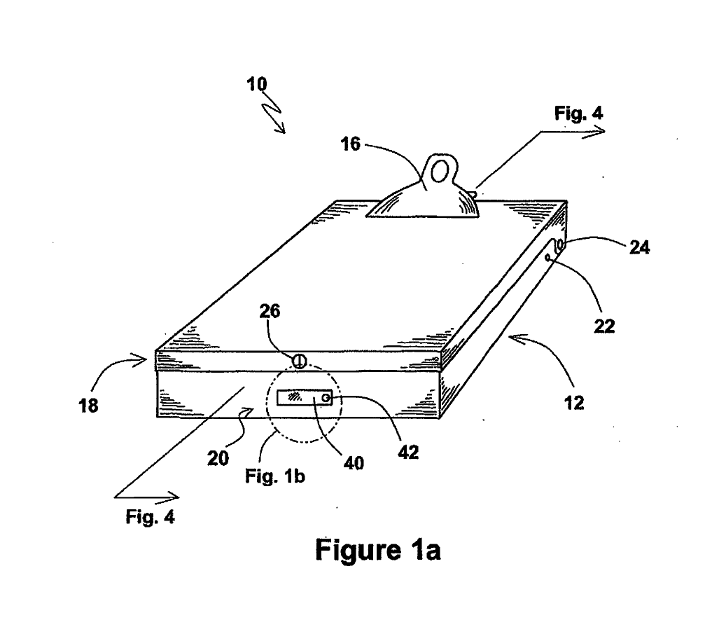

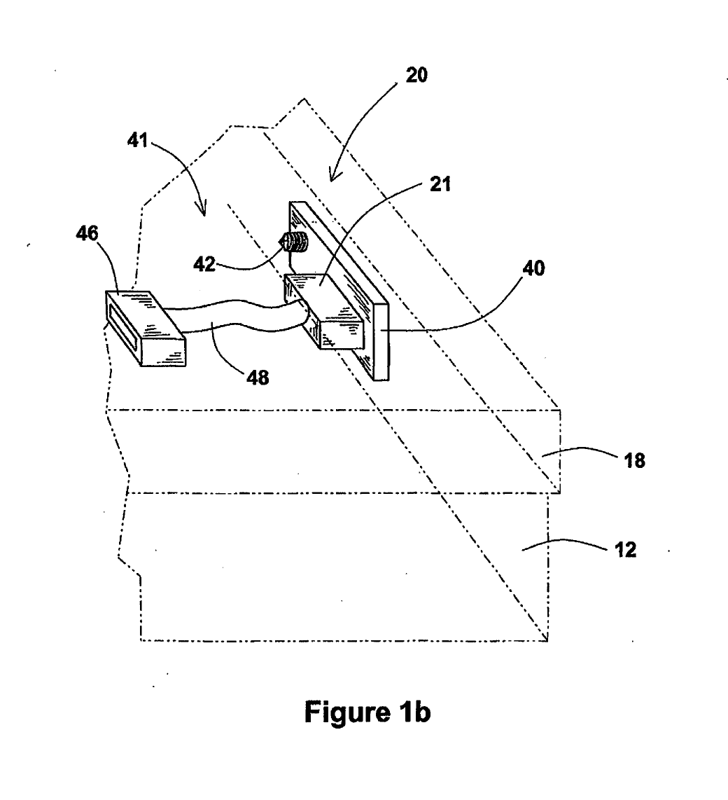

Turning to FIG. 1a, there is illustrated a perspective view of one embodiment of the invention 10 positioned in a horizontal orientation while being closed to access to the interior therein. Uniquely, in one embodiment, the case 10 has the following components: A bottom or container portion 12 and top or cover portion 18 are integrally positioned in known and illustrated fashion to seal and enclose a computer pad device (not shown) therein. A hinge mechanism 24 couples the top 18 to the bottom 12 portions in a known fashion to allow the top 18 to pivotally open from the bottom 12 to enable entry therein. A locking mechanism 26 is positioned to fixedly couple the top 18 to the bottom portion 12 in any known fashion. The locking mechanism 26 is positioned at a furthest position from the hinge mechanism 24. A retainer mechanism 16 is positioned on a top surface of the cover 18 and may be used to retain paper on the top surface of the cover 18 to assist the user in writing on the paper (not shown). An electrical coupling 20 is positioned at an opposite end of the container 10 from the retainer mechanism 16. The electrical port or coupling 20 has a pivotal cap/cover 40 and cap hinge mechanism 42. The electrical coupling 20 may be for an external power hookup coupling. A second electrical coupling 22 is positioned on a side of the container 10 and closer to the retainer 16 than the lock 26. The bottom portion 12 and the top portion 18 of the case 10 form a case cavity for storing the computer pad.

FIG. 1b illustrates a perspective sectional phantom line view of one embodiment of an interior electrical coupling 21 as illustrated in FIG. 1a. Additionally, there is a jumper cable 4 I that includes an electrical coupling 21, a cord 48 and a second coupling 46 extends from the wall of the bottom portion of the case 10 to an internal region of the case 10. Ideally, the cable 41 will be longer than the cavity to allow for easy attachment and un-attachment from the computer pad 32. Also illustrated is the movable cover 40 and hinge mechanism 42.

FIG. 2 illustrates a perspective view of one embodiment of the open case of FIG. 1 a. Additionally, there is illustrated a cavity 30, with a lower surface or shelf 28, that hingedly couples, via hinge mechanism 29, to the interior wall of the case 10 as illustrated. The cavity 30 is designed to allow for storage of items, like paper, within the case 10 while closed.

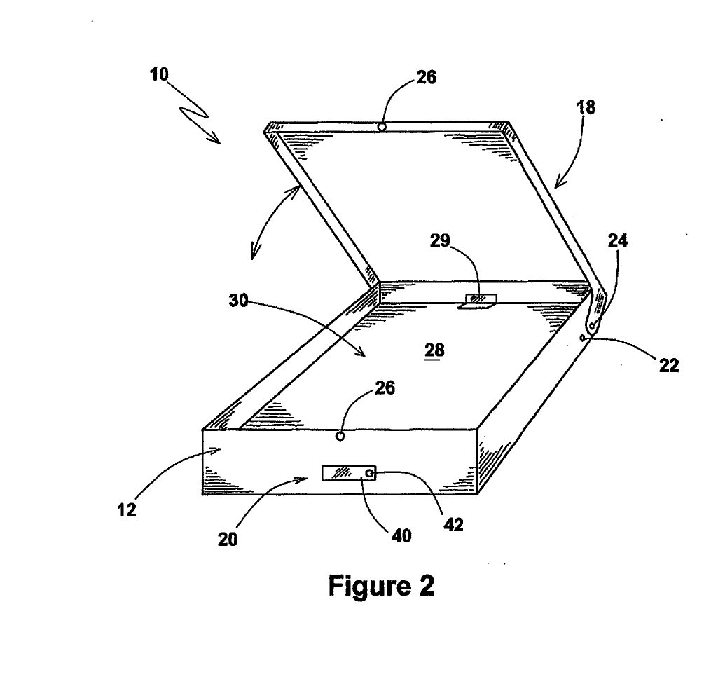

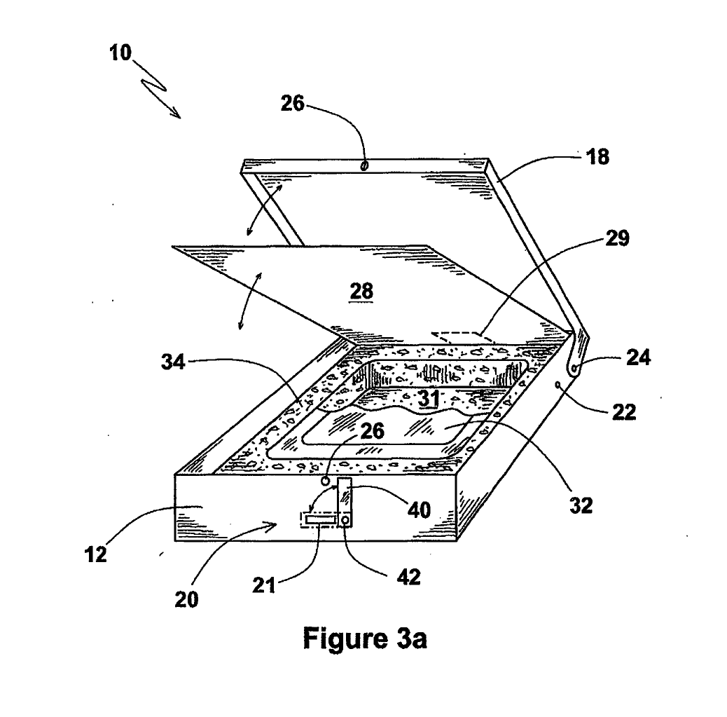

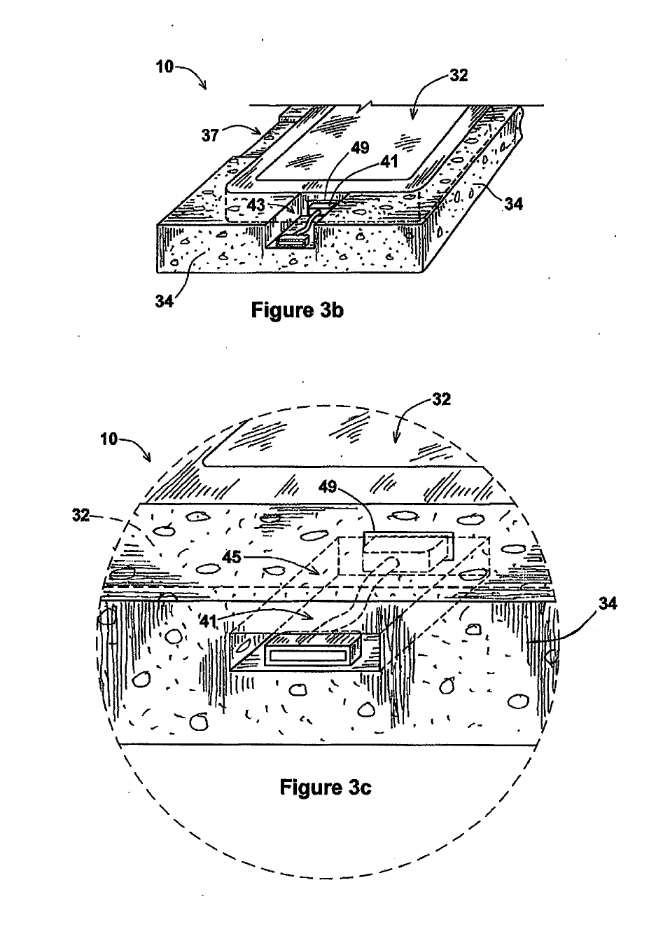

FIG. 3a illustrates a perspective view of one embodiment of the open case of FIG. 2. In addition to the previous elements described in the preceding specification and drawings, there is shown the elements that may exist under the shelf 28. Uniquely, there is a cavity 31 located inside a protective lining 34 (also referred to as a protective layer, or a insulative layer, or supportive layer, or spacing layer), a sectional view of a computer pad 32 mounted in the cavity 31, and an illustration of cover 40 in a rotated position to expose the electrical coupling 21. As illustrated the supportive layer 34 supports the computer pad 32 within the lower part of the computer case 10. In particular, the computer pad 32 is supported, covered or abutting on all sides except the top screen side, and, as illustrated, the support layer 34 creates a space or wall between the computer case 10 walls and the computer pad 32. The space may be equally distanced or may not. It is pointed out that the space around the computer pad 32 forms the walls and bottom of the insulative layer 34.

FIG. 3b illustrates a sectional perspective view of FIG. 3a with the case housing 12 and 18 removed from the illustration. Uniquely, in this embodiment, there is illustrated the jumper cable 41 that is coupled to the computer pad 32 via an input electrical coupling 49 of known design for known purposes. The protective lining 34 may have a jumper cable cavity 43 extending from the input coupling 49 to the portal 20 to allow for the jumper cable 41 to extend therethrough. The cavity 43 also allows for the user to reach in the case and couple or decouple the computer pad 32 to/from the jumper cable 41 every time the pad 32 is placed or removed therefrom. An additional storage cavity 37 may be located in the protective or insulative layer, or just layer 34, as illustrated and serves as a storage cavity for pens, pencils, paper clips, etc.

FIG. 3c illustrates a different embodiment than FIG. 3b, and is a sectional perspective view of FIG. 3a with the case housing removed. Uniquely, there is illustrated a channel 45 that has covering on all sides, top, bottom, and all sides. This design will retain the cable 41 therein. The cavity 45 may be larger than what the dimensions of the cable are to allow for coiling of the longer jumper cable 41. Additionally, in an additional embodiment, the channel 45 may be snuggly fitting to the cable 41.

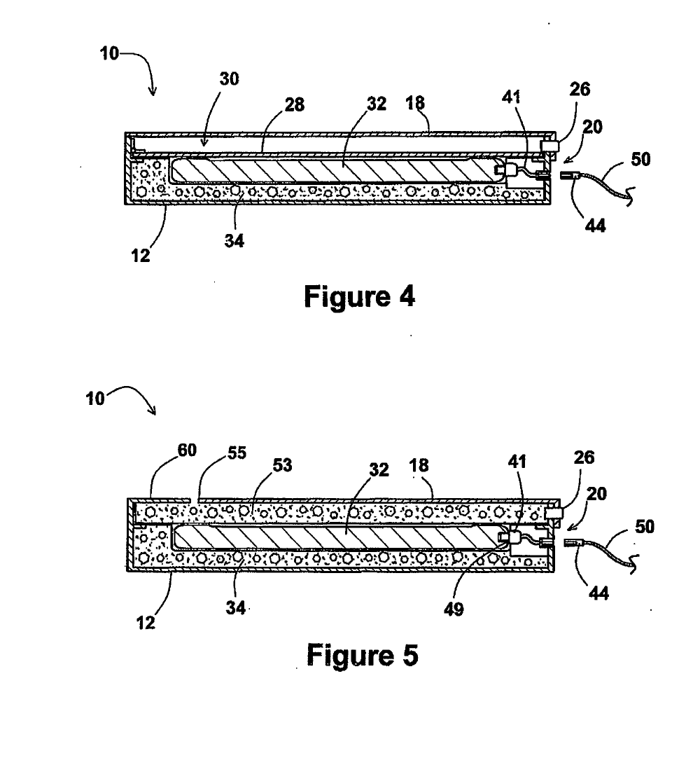

FIG. 4 illustrates a cross sectional view of FIG. 3 in a closed position. Additionally, there is an external cord 50 with a coupling mechanism 44 that is designed to be coupled to the jumper cable 41 in a known manner. The coupling mechanisms mounted to the ends of the cables 41 and 50 may be most any known type, such as a common U.S.B. (universal serial bus) coupling or others. Specifically, it is illustrated that computer pad coupling 49 is located near the cavity xx such that jumper cable 41 is the shortest as possible and can be reached easily by the user to couple the jumper cable 41 to the computer pad 32 when placing the computer pad 32 within the cavity 31 of the resilient protective layer 34. Wherein, lock mechanism 26 is able to be locked shut during coupling of cable 51 to cable 41 to computer pad 32.

This illustrated design of FIG. 4 demonstrates that the user has the case 10 closed while recharging power or downloading/uploading data to the computer pad 32. Thus, the exterior cables 50 do have to hang over the top edges of the case and into the cavity 31 to be coupled to the computer pad 32 and preventing the case from completely closing and/or locking via lock mechanism 26.

FIG. 5 illustrates a cross sectional view of another embodiment of the illustrated invention having only one interior cavity for the computer pad. Specifically, in this embodiment, protective padding 53 is placed in the cover 18 to protect the computer pad 32 while placed in the computer case 10. Additionally, there is illustrated an optional design of the case 10, where the top cover 18 does not extend all the way to the top edge and stops at edge 55. Likewise, bottom section 12 extends upward and around to the top as section 60, as precisely illustrated.

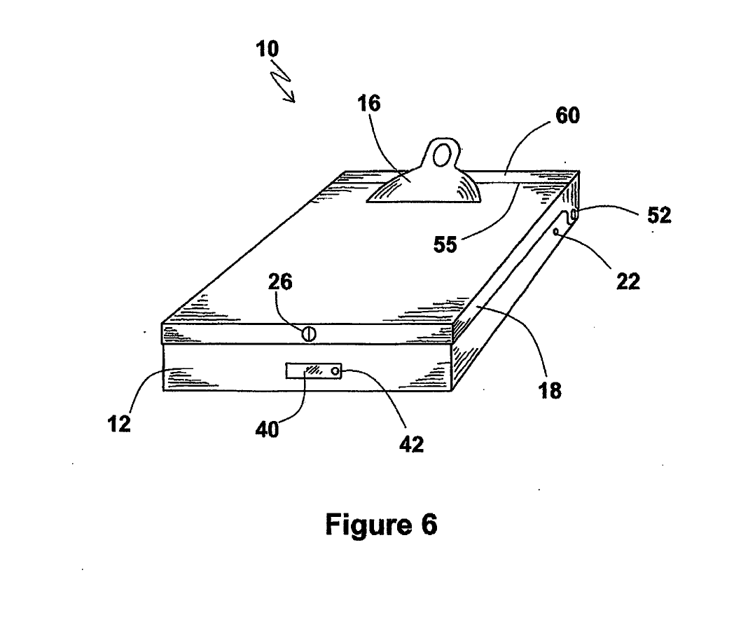

FIG. 6 illustrates a perspective view of another embodiment of the invention positioned in a horizontal orientation while being closed to access to the interior therein. In particular, top section 60 is integrally coupled to the bottom section 12. Top cover 18 extends up to edge 55, also referred to as a rotation stop device, and has coupling pivot device 52 located in a bottom location of the bottom wall 12, as precisely illustrated.

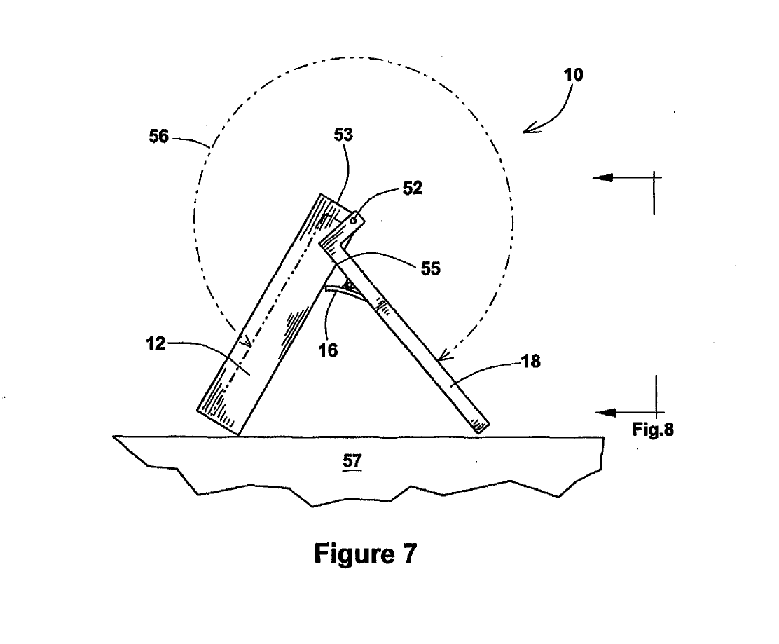

FIG. 7 illustrates a side view of one embodiment of the propped up and open case from FIG. 6. In particular, the top cover 18 is rotated over 180 degrees 56, and may be rotate any amount of rotation, but only as far as edge 55 abutting up against the bottom of case section 12 and resting on a horizontal surface 57, as illustrated. In this embodiment, the cover 18 is able to prop up the computer pad 32 in a relatively vertical orientation to allow for easy visibility to multiple people sitting around the case 10. Top surface 53 of the bottom portion 12 of case 10 is oriented upward.

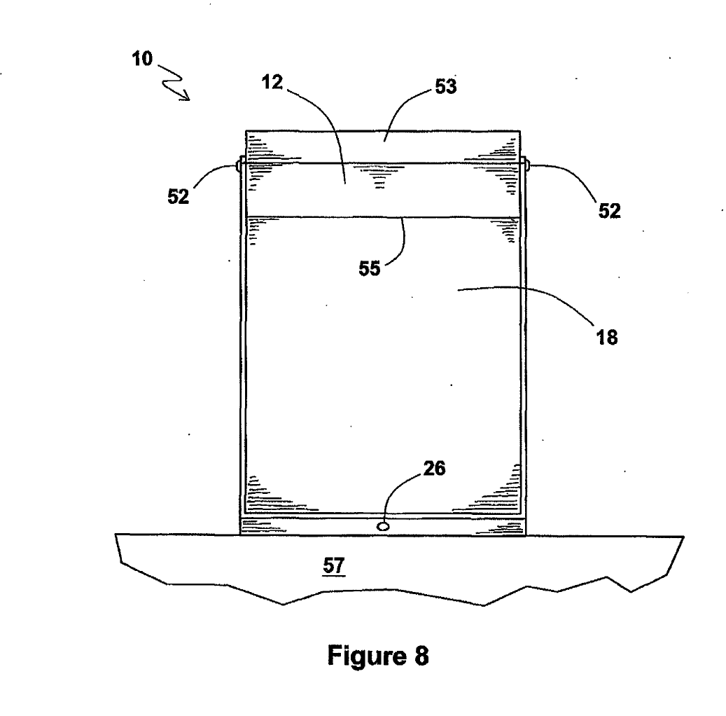

FIG. 8 illustrates a back view of FIG. 7 while in the propped up and open case 10 positions. In particular, this view provides a second perspective of how edge 55 abuts the bottom 12 of case 10 and reveals the interior of cover 18 and positions surface 53 in an upward position as the whole case 10 is mounted on a horizontal surface 57.

It is understood that the above-described embodiments are only illustrative of the application of the principles of the present invention. The present invention may be embodied in oilier specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the illustrated embodiments illustrate only two exterior electrical portals 20 and 22 in the case 10, it is easily contemplated that any number of portals may be constructed. It is also noted that the portals are specifically designed to be located directly in line with, as best as possible, across from the actual electrical connections positioned on the computer pad 32. Thus, head phone jacks are located on the outside next to the head phone jack plug on the computer pad, etc.

Additionally, although the figures illustrate only a short extension of cord/cable 48 for jump cables 41, etc., the cable may be as long as desired. Thus, the user may even wind up extra length of cord 48 and place it in the cavity 43, 45.

Yet, it is further illustrated that the cover 18 can rotate to form an acute angle with the bottom surface of the bottom container 12, it is understood that most any angle can be formed therebetween to enable the vertically oriented propping of the computer pad 32 for easier visibility.

It is also envisioned that that may be many cavities 37 located in the interior layer 34. This cavity 37 illustrates that there may be of any number, size and depth located all along the periphery of the protective layer 34 to store any number of known items needed by users of computer pads 32, such as pens, thumb drives, paper clips, etc.

It is expected that there could be numerous variations of the design of this invention. An example is that the protective layer 34 may be made of any known material that would act as a protective layer for the computer pad 32. Known examples are all types of closed cell material, like poly-foam materials, or even relatively hard materials to the touch yet act as protective impact resilient material. Additionally, the protective layer 34 is portrayed as being a relatively thick material, whereas in fact, it may be a very small and thin layer that is sufficient to protect the computer pad 32.

It is also illustrated that the invention is a typical box like design, and although the present specification does not discuss the parts of a typical box and cover, one skilled in the art of simple boxes will realize that a box has four sides and a bottom side, and for sides and a top side for the cover, and as such, these elements are not labeled but may be referred to in known configuration in the claims and in understanding the features of the patentable invention. Similarly, it is not described that the top cover has a wider and longer dimension than the bottom section, since this too is well understood in the simple art of how boxes operate and are designed.

Further, it is illustrated only two types of cavities 43 or channel 45, wherein per the allowed variations and intended scope of the invention not needed to be illustrated, it is intended to have any form of cavity imaginable. Specifically, there may be a partial channel and a partial cavity, there may be a removable lid to the cavity that hides the cavity when not in use, but may be removed to allow for access thereto. The lid may be made of the same insulative or supportive layer material or other material. This lid may also be placed over side storage cavities 37 where pens and pencils are described herein to be stored.

It is also illustrated many features of different embodiments of the invention that are purely embodied in the figures, attached hereto. Specifically, the positioning of different features are clearly illustrated and are not described in detail, since one skilled in the art of reading drawings would clearly understand these features. For example, the protective layer 34 is illustrated to be completely abutting the computer pad 32 and is not detailed described since this is beyond what is needed for even the simplest of readers to understand this feature.

It is also clearly illustrated that the top 12 is integrally fitted around the bottom 18 of the case 10. Again, this is too rudimentary to describe on how cases may be fit together, and is not part of the patentable features. In fact, despite the illustrating of the fitting of the top and bottom 12, 18, one skilled in the art knows of many other methods for fitting such part together and are not described but are incorporated in the invention as are hundreds of variation that are assumed and are not stated explicitly.

Although not specified, the rotative attachment devices 52 is not described in detail since one skilled in the art are familiar with hundreds of possible designs to allow for a top 18 to be able to uncover the interior of a bottom compartment 31 in a bottom section 12, and all are incorporated by reference to be acceptable substitutes thereto.

Additionally, although not specifically described, the fitting of the computer pad 32 within the supportive layer 34. It is too rudimentary to describe all the possible fitting limitations that are possible between such elements. Specifically, there could be a loose fitting, a tight fitting, a combination of both, a hook and eye attachment between such devices, a latching mechanism to hold the computer pad therein, and hundreds of other means too numerous to describe.

Finally, it is envisioned that the components of the case 10 may be constructed of a variety of materials, like metals (steel, aluminum, etc.), or plastics of any kind.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to, consist of, or to consist essentially of one or more of the features, functions, structures, methods described herein.

What is claimed by Letters Patent is:

1. A computer case that is designed to contain a computer pad with an electrical port, and a jumper cable removably coupled to the electrical port, comprising:
a) a bottom compartment, defined by a first and second pair of opposed bottom walls that are all connected by one bottom wall;
b) a top cover, including a first and second pair of opposed top walls all connected by one top wall; and
c) a spacing layer, formed to substantially fill the bottom compartment, including:
i) a computer pad cavity formed in a central region of the spacing layer and creating a first and second pair of opposed spacing walls all connected by one spacing wall therebelow that the computer pad rests thereon; and
ii) a jumper cable cavity, extending from an edge of the computer pad, positioned next to the electrical port, and terminating at a case electrical port, to enable the jumper cable to be placed within the jumper cable cavity and be coupled to the computer pad and one of the first and second pair of opposed bottom walls of the bottom compartment

2. The computer case of claim 1, further comprising a storage cavity, located in a top surface of the spacing layer, designed to contain storable items therein.

3. The computer case of claim 2, further comprising a retainer mechanism, positioned on a top surface of the top cover, designed to hold paper in a flat orientation on the top cover thereon.

4. The computer case of claim 2, further comprising a rotative coupling, positioned to loosely hold the top cover to the bottom compartment, designed to allow the top cover to pivotally rotate about the rotative coupling and continuously maintain attachment to the bottom compartment.

5. The computer case of claim 4, wherein the top cover rotates over one hundred and eighty degrees.

6. The computer case of claim 5, wherein the top cover rotates sufficiently to form an acute angle with the bottom of the bottom compartment.

7. The computer case of claim 6, further comprising a rotation stop device, positioned on the top cover, designed to prevent further rotation of the top cover.

8. The computer ease of claim 7, wherein the rotation stop device is an edge of the top cover that abuts to the back surface of the bottom compartment upon rotation thereof.
